(19) United States
(12) Patent Application Publication
(10) Pub. No.: US 2015/0381671 A1
(43) Pub. Date: Dec. 31, 2015

(54) VIRTUAL FILE SHARING METHOD

(71) Applicants: Quanta Computer Inc., Tao Yuan Shien (TW); STREAMING21 INTERNATIONAL INC., San Jose, CA (US)

(72) Inventors: Jung-Shen LEE, Hsinchu City (TW); Meng-Jou LIN, New Taipei City (TW)

(73) Assignees: QUANTA COMPUTER INC., Tao Yuan Shien (TW); STREAMING21 INTERNATIONAL INC., San Jose, CA (US)

(21) Appl. No.: 14/459,396

(22) Filed: Aug. 14, 2014

(30) Foreign Application Priority Data
Jun. 30, 2014 (TW) 103122516

(51) Int. Cl. H04L 29/06

(52) U.S. Cl. CPC H04L 65/403

(57) ABSTRACT

A virtual file sharing method is disclosed. The method comprises following steps. A device joins a group. A virtual sharing pool corresponding to the group is created. Another device joins the group. The other device shares the virtual sharing pool of the group. The device chooses a file to share to the group. File information corresponding to the shared file is shown in the virtual sharing pool. The other device selects file information from the virtual sharing pool to access the file from the device.

This application claims the benefit of Taiwan application Serial No. 103122516, filed Jun. 30, 2014, the subject matter of which is incorporated herein by reference.

### BACKGROUND OF THE INVENTION

1. Field of the Invention

The invention relates in general to a virtual file sharing method, and more particularly to a virtual file sharing method which creates a virtual sharing pool for sharing the files.

2. Description of the Related Art

As mobile devices have gained a great popularity, mobile phones, tablet PCs and wearable devices have been widely used. In general, each device has its own storage space which may range from 8 G to 128 G. However, it is indeed a technique challenge to move or access data between different devices, and may cause inconvenience of use to those users who have several mobile devices.

Therefore, how to provide a file sharing technique capable of effectively integrating storage spaces of different devices has become a prominent task for the industries.

### SUMMARY OF THE INVENTION

The invention is directed to a virtual file sharing method capable of showing to-be-shared files of several devices of the same group in a virtual sharing pool for each device of the same group to access.

According to one embodiment of the present invention, a virtual file sharing method is disclosed. The method comprises following steps. A device joins a group. A virtual sharing pool corresponding to the group is created. Another device joins the group. The other device shares the virtual sharing pool of the group. The device chooses a file to share to the group. A file information corresponding to the shared file is shown in the virtual sharing pool. The other device selects the file information from the virtual sharing pool to access the file from the device

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a flowchart of a virtual file sharing method according to an embodiment of the invention.

FIG. 2 is a schematic diagram of a group device and its corresponding virtual sharing pool according to an embodiment of the invention.

FIG. 3 is a schematic diagram of a public mode of a virtual file sharing method according to an embodiment of the invention.

FIG. 4 is a schematic diagram of a private mode of a virtual file sharing method according to an embodiment of the invention.

FIG. 5 is a schematic diagram of a cloud server aided mode of a virtual file sharing method according to an embodiment of the invention.

FIG. 6 is an example of a user interface for creating a private group.

FIG. 7 is an example of a user interface for joining a private group.

### DETAILED DESCRIPTION OF THE INVENTION

A number of embodiments are disclosed below for elaborating the invention. However, the embodiments of the invention are for detailed descriptions only, not for limiting the scope of protection of the invention. Furthermore, secondary or unimportant elements are omitted in the accompanying diagrams of the embodiments for highlighting the technical features of the invention.

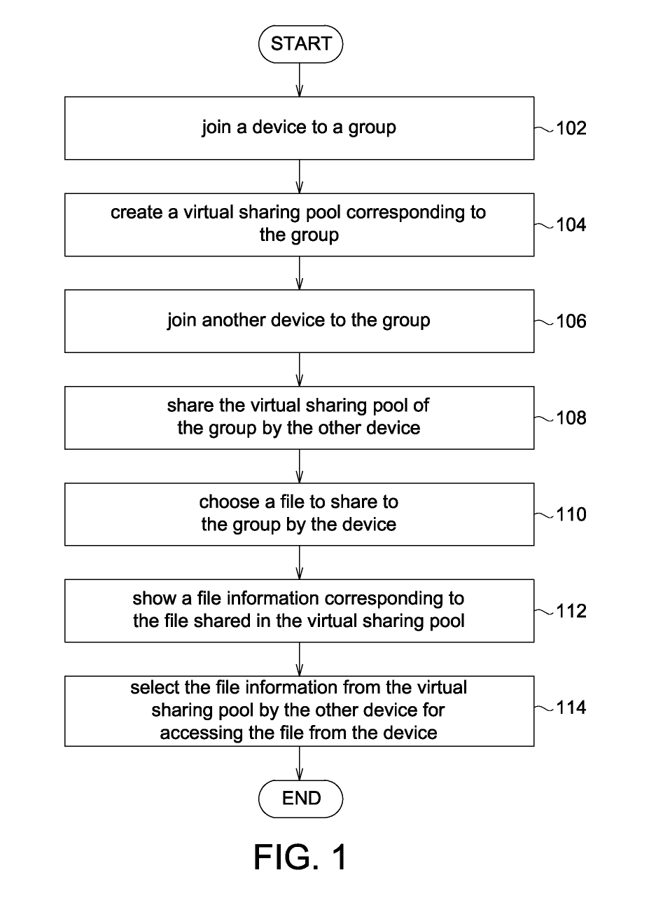

FIG. 1 is a flowchart of a virtual file sharing method according to an embodiment of the invention. The virtual file sharing method is used between devices for showing the to-be-shared files of several devices of the same group in a virtual sharing pool for each device of the same group to access. In step 102, a device joins a group. The device can be the device creating the group and belonging to the group. Or, the device can create a communication link with another device of the group to join the group. For example, the device creates a peer-to-peer transmission link with another device of the group.

In step 104, a virtual sharing pool corresponding to the group is created. For example, when the device creates a peer-to-peer transmission link with another device of the group, file information is synchronically shared between devices of the same group in a peer-to-peer manner to create a virtual sharing pool. The virtual sharing pool can be realized by a user interface for showing to-be-shared files of each device of the group. In an example, the virtual sharing pool further show the icon of each device of the group so that the user can understand which devices are included in the group along with other information such as the models, storage capacities and/or users of the devices.

In step 106, another device joins the group. Based on the design needs or the nature of the environment, the other device can create a communication link with another device of the group by using a suitable communication technique such that the other device can join the group via the communication link.

In step 108, the other device shares the virtual sharing pool of the group. In step 110, the device chooses a file to share to the group. The file is such as a file stored in the device. In an example, when the device intends to share a file to the group, the device can register the file on a virtual sharing record list for sharing the file to the group.

In step 112, the file information corresponding to the shared file is shown in the virtual sharing pool. As disclosed above, when the file is registered in the virtual sharing record list, the content of the virtual sharing pool will be synchronically updated to show the file information of the shared file. It is noted that in the above step, the virtual sharing pool merely shows the file information of the file shared to the group by a sharing device, but the file is still stored in the sharing device.

In step 114, the other device selects a file information from the virtual sharing pool to access a corresponding file from the sharing device. For example, when the other device of the group selects a file information provided by a sharing device from the virtual sharing pool, the sharing device will transmit stream of the shared file to the other device.

Based on the above disclosure, the virtual file sharing method of an embodiment of the invention shows the to-be-shared files of several devices of the same group in a virtual sharing pool for each device of the group to access. Each shared file can be directly accessed from the local host by other device of the same group without having to be physically written to the virtual sharing pool, hence saving extra storage space for storing the shared file. In terms of the devices of the same group, when an external device is added to the group, the equivalent storage space of the virtual sharing pool increases accordingly, such that the limitation in the storage space of the devices can be resolved. For example, when a mobile phone having a storage space of 8 G and a tablet PC having a storage space of 32 G are combined as one group, the equivalent virtual sharing pool will have a storage space of 40 G (8 G+32 G) in total.

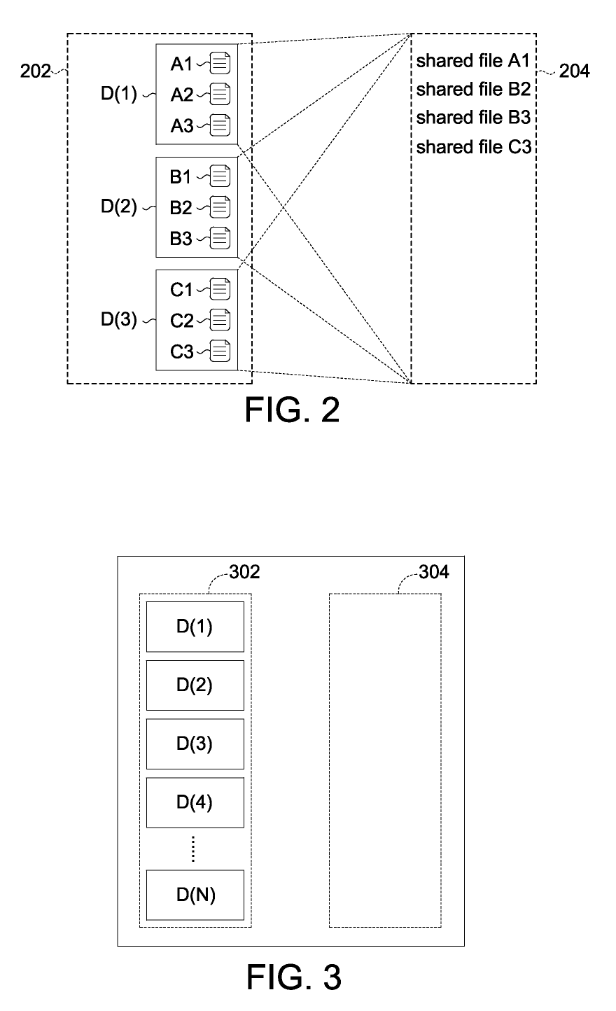

FIG. 2 is a schematic diagram of a group device and its corresponding virtual sharing pool according to an embodiment of the invention. In the example of FIG. 2, devices D(1), D(2) and D(3) respectively store files A1˜A3, files B1˜B3 and files C1˜C3. The devices D(1), D(2) and D(3) find each other by way of peer-to-peer transmission and create a transmission link to create a group 202 and correspondingly create a virtual sharing pool 204. Suppose the device D(1) chooses to share the file A1 to the group 202, the device D(2) chooses to share the files B2 and B3 to the group 202, and the device D(3) chooses to share the file C3 to the group 202, the virtual sharing pool 204 shows the information corresponding to the files A1, B2, B3, C3, such that each of the devices D(1), D(2), D(3) of the group 202 can know the files that are currently shared in the group 202. The information corresponding to the files can be texts (such as “share file A1” to “share file C3”) or graphics.

In the present embodiment, after the device joins the group 202, the device can show a corresponding virtual sharing pool 204. When the device intends to access a particular file, the device can click on the file information corresponding to the shared file (such as “share file A1”) of the virtual sharing pool 204 to directly receive the stream of the shared file from the device in which the shared file is stored. Suppose the to-be-shared file is a text file or other editable file. The device with required permission can directly open and edit the shared file through the virtual sharing pool 204. The device of the same group can directly access a shared file from the device in which the file shared. Therefore, when a device intends to share a file, the device does not need to physically copy the file to the virtual sharing pool 204.

The virtual file sharing method of an embodiment of the invention can at least be divided into four modes, namely, (I) public peer-to-peer mode, (II) private peer-to-peer mode, (III) cloud server aided mode, and (IV) cloud server hosting mode. The four modes are respectively disclosed below. It is understood that the quantities of devices and files, disposition of devices and structure of the group exemplified below are for description purpose only, not for limiting the invention, and may be adjusted to fit actual needs.

### (I) Public Peer-to-Peer Mode:

FIG. 3 is a schematic diagram of a public peer-to-peer mode of a virtual file sharing method according to an embodiment of the invention. In the example of FIG. 3, devices D(1)˜D(N) find each other by way of broadcasting, N is a positive integer, a transmission link is created between the devices to create a public group 302, and a virtual sharing pool 304 is correspondingly created. The devices D(1)˜D(N) can find each other by periodically broadcasting their presence information or exchanging their presence information with other device. When a newly joined device is found, the group identification code of the broadcast information transmitted by the newly joined device determines whether the newly joined device belongs to any private group. If the group identification code of the newly joined device is null or corresponds to a public group identification code, the newly joined device joins a public group 302. The device of the group 302 can create a communication connection with the newly joined device through a peer-to-peer transmission mechanism and add the newly joined device to a device list of the group 302. After the device joins the public group 302, files can be shared between the devices of the group 302 by way of peer-to-peer streams. In an example, the initial mode of the device can be set as public peer-to-peer access mode. That is, the predetermined group to which the device enters can be set as a public group in the local network.

In another example, the predetermined group to which the device enters can be set as an inherent group. The connection of the inherent group pre-exists by way of keeping previous relevant parameters of the group (such as the parameter of a device which once joined the group). For example, after a device joined a group and then left, the connection setting of the group will be recorded. Later on, when the device intends to join the group again, the device can quickly join the group because relevant setting parameters are already stored.

### (II) Private Peer-to-Peer Mode:

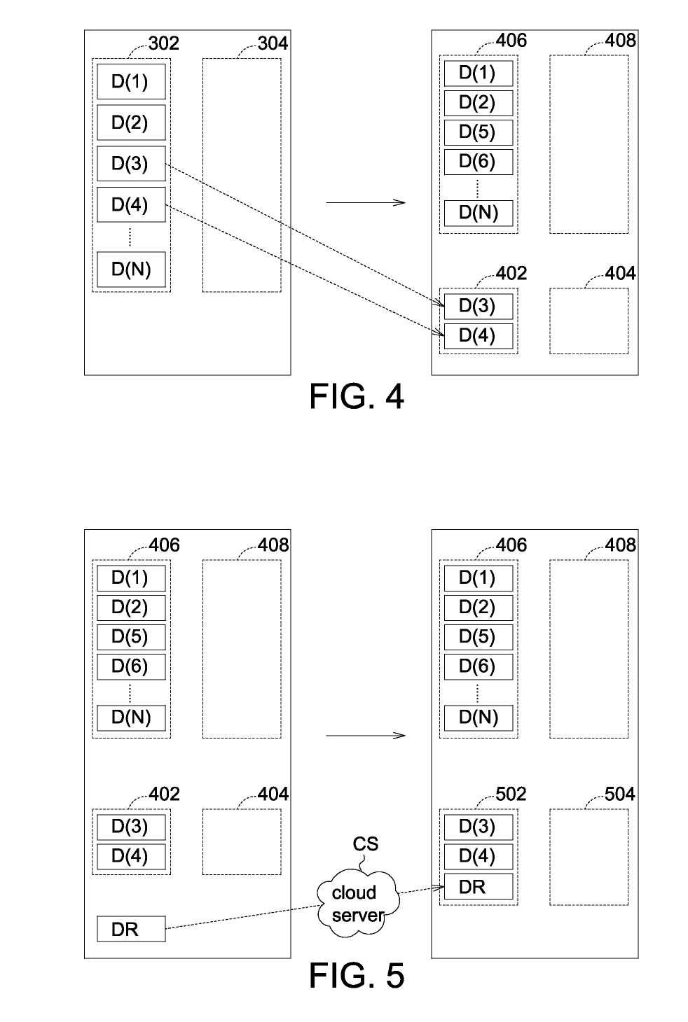

FIG. 4 is a schematic diagram of a private peer-to-peer mode of a virtual file sharing method according to an embodiment of the invention. In the example of FIG. 4, the devices D(3) and D(4) which originally belonged to the public group 302 in FIG. 3 are moved to a newly created private group 402 and create a corresponding private virtual sharing pool 404. Since the newly altered public group 406 does not include the devices D(3) and D(4), its corresponding virtual sharing pool 408 lacks the files shared by the devices D(3) and D(4). Let the creation of the private group 402 by the device D(3) be taken for example. After the device D(3) creates the private group 402, the device D(3) is moved to the private group 402 from the public group 302 and a corresponding virtual sharing pool is created. Then, the device D(3) invites the device D(4) to join the private group 402 such as by transmitting an invitation code or a private key. The device D(4) immediately joins the private group 402 after inputting the invitation code or the private key, and creates a corresponding virtual sharing pool 404 together with the device D(3). In the present example, the file information of the virtual sharing pool 404 is shared by the devices D(3) and D(4) of the group 402, and the file information of the virtual sharing pool 408 is shared by the devices D(1), D(2), and D(5)-D(N) of the group 406. Since only the devices of the corresponding group can see the information of shared files of the corresponding virtual sharing pool, the files shared by devices of the private group 402 will not be seen by devices of other group (such as the public group 406).

In the present mode, the mechanism for finding another device is similar to that in the public peer-to-peer mode. That is, a device can transmit a broadcast signal to inform other device of its presence information. Once the device is found, the device can join a corresponding group through a group identification code contained in the broadcast signal. Let the group identification code of the private group 402 be “AAA”. Suppose the group identification code of the broadcast information transmitted by the newly joined device is also “AAA”. Once the newly joined device is found, the newly joined device will be added to the private group 402.

### (III) Cloud Server Aided Mode:

FIG. 5 is a schematic diagram of a cloud server aided mode of a virtual file sharing method according to an embodiment of the invention. In the example of FIG. 5, with the assistance of the cloud server CS, a remote server device DR is added to the private group 402 created by the devices D(3) and D(4) of FIG. 4 to create a new group, that is, group 502, and correspondingly creates a virtual sharing pool 504. The remote device DR, such as located in a remote network area, can transmit an invitation or a file access request to the device of the private group 402 according to the address information transmitted from the cloud server CS so as to create a peer-to-peer connection with the device of the private group 402. For example, when the remote device DR intends to access the file shared by the device D(3), firstly, the remote device DR can transmit an access request to the cloud server CS. After receiving the access request, the cloud server CS transmits the IP address and/or port information of the device D(3) to the remote device DR, such that the remote device DR can create a connection with the device D(3) according to the IP address and/or port information of the device D(3). After obtaining permission from the device D(3), the remote device DR can access the file shared by the device D(3). For example, the remote device DR receives the stream of the file shared by the device D(3).

In another example, after receiving the request for accessing the device D(3) from the remote device DR, the cloud server CS will wait for the inquiry information transmitted from the device D(3). After receiving the inquiry information from the device D(3), the cloud server CS will transmit a file access request to the device D(3). In response to the file access request, the device D(3) will transmit the file content requested by the cloud server CS to the cloud server CS, which will accordingly transmit the file content to the remote device DR. With the assistance of the cloud server CS, the remote device DR can obtain the files shared by the device D(3).

In the present mode, the mechanism for finding device can be implemented by the cloud server CS. For example, when a newly joined device having group identification code “AAA” logs in the cloud server CS, the cloud server CS firstly will verify the device information and group identification code of the newly joined device. If the verification is successful, the cloud server CS will transmit the device information and group identification code of the newly joined device to other devices of the group when the other devices log in the cloud server CS. Thus, the other devices of the group can find the newly joined device and further create a connection with the newly joined device through the received information.

### (IV) Cloud Server Hosting Mode:

In the present mode, at least a private group (such as the private group 402 of FIG. 4) is created in the cloud server CS which hosts relevant management operations of the private group. Similarly, the private group of the above example has a corresponding virtual sharing pool. When a device transmits a file sharing information of a shared file to the cloud server CS, the cloud server CS will update the content of the virtual sharing pool to show the information of the shared file in the corresponding virtual sharing pool. In the present mode, the cloud server CS hosts the management of the private group. Therefore, when a device intends to share a file to the private group of the cloud server CS, the cloud server CS firstly will determine whether the device has registered. If the device has registered, the cloud server CS will transmit an authorization information to the device to provide an authorization of file sharing to the device, and the cloud server CS will update the virtual sharing pool in response to the file sharing information of the device. Likewise, if a device intends to access the content of the virtual sharing pool, the cloud server CS, after confirming that the device is a registered device, will transmit the information of the shared file in the virtual sharing pool to the registered device.

In an example, the private group of the cloud server CS exists only when the group has devices. After the last device of the private group exits, the private group will be automatically deleted. In another example, the private group of the cloud server CS can only be deleted manually. That is, even when the private group does not have any device, the private group does not disappear automatically, and the cloud server CS will still keep relevant parameter of the private group (such as the parameters of all devices ever joined the group). Under such circumstance, the device, which exited the group but now intends to join again, will be promptly recognized by the cloud server CS and accepted as a device of the group.

In the present mode, the mechanism for finding device can be implemented by the cloud server CS. For example, when a newly joined device having group identification code “AAA” logs in the cloud server CS, the cloud server CS firstly will determine whether the newly joined device has registered and then verify the device information and group identification code of the newly joined device. If the verification is successful, the cloud server CS will add the newly joined device to a private group corresponding to the group identification code “AAA”, update the group device list, and transmit the updated group device list to each device of the group.

In an example, when a device intends to register to the cloud server CS, the device will transmit a registration request to the cloud server CS. When receiving the registration request, the cloud server CS will execute a series of verification procedures. For example, the cloud server CS will verify the application used by the device (such as the application for registering to the cloud server CS), the user information (such as the owner of the device), and the device information (such as the model, operating system, and storage space of the device) in sequence. If the above items of verification are all successful, the cloud server CS will record the device as a registered device.

According to the virtual file sharing method of an embodiment of the invention, the device can join a particular private group by inputting an invitation code (such as a group identification code). Furthermore, once a private group is created, an invitation code of the private group will be correspondingly generated. When a device intends to join the group, whether the device has the invitation code will be determined. If the device has the invitation code, the device will join the private group corresponding to the invitation code. Conversely, if the device does not have the invitation code, the device will join a default public group of the local network.

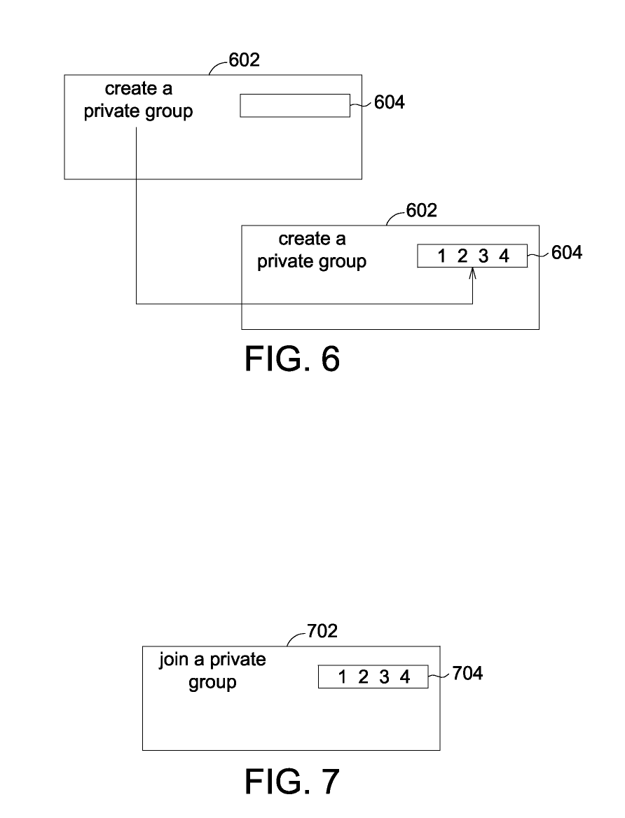

Referring to FIG. 6, an example of a user interface 602 for creating a private group is shown. The user interface 602 comprises an input region 604. If a device intends to create a private group, the user can activate a user interface 602 on the device and generate a unique corresponding invitation code of the private group in the input region 604, such that other devices can join the private group by inputting the invitation code. In the example of FIG. 6, the invitation code of the newly created private group is set as “1234”.

Referring to FIG. 7, an example of a user interface 702 for joining a private group is shown. The user interface 702 comprises an input region 704. If a device intends to join a particular private group (such as the private group created in the example of FIG. 6), the user can create the user interface 702 on the device, and input a corresponding invitation code of the private group to the input region 704. As indicated in FIG. 7, after inputting the invitation code “1234” to the input region 704 of the user interface 702, the user will join the private group created in the example of FIG. 6.

To summarize, the virtual file sharing method of an embodiment of the invention shows the to-be-shared files of several devices of the same group in a virtual sharing pool for devices to access. Each shared file can be directly accessed from the local host by other device of the same group without having to be physically written to the virtual sharing pool, hence saving extra storage space for storing the shared file. In terms of the devices of the same group, when an external device is added to the group, the equivalent storage space of the virtual sharing pool increases accordingly, such that the limitation in the storage space of the devices can be resolved.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A virtual file sharing method, comprising:
joining a device to a group;
creating a virtual sharing pool corresponding to the group;
joining another device to the group;
sharing the virtual sharing pool of the group by the other device;
choosing a file to share to the group by the device;
showing a file information corresponding to the file shared in the virtual sharing pool; and
selecting the file information from the virtual sharing pool by the other device for accessing the file from the device.

2. The virtual file sharing method according to claim 1, further comprising:
updating the virtual sharing pool to add file sharing information of the other device; and
receiving a file stream from the device by the other device.

3. The virtual file sharing method according to claim 2, further comprising:
transmitting a broadcast signal by the other device; and
creating a communication connection with the other device by the device when receiving the broadcast signal transmitted from the other device, wherein the other device joins the group via the communication connection.

4. The virtual file sharing method according to claim 2, wherein the other device receives the file stream from the device by using a peer-to-peer technique.

5. The virtual file sharing method according to claim 2, further comprising:
transmitting a request for accessing the file to a cloud server;
receiving location information of the device from the cloud server;
receiving the file stream from the device according to location information of the device.

6. The virtual file sharing method according to claim 2, further comprising:
creating another group and changing to join the other group by the other device; and
creating another virtual sharing pool corresponding to the other group;
wherein, the file information of the virtual sharing pool is shared by devices of the group, and the file information of the other virtual sharing pool is shared by devices of the other group.

7. The virtual file sharing method according to claim 6, further comprising:
generating an invitation code corresponding to the other group;
determining whether another device has the invitation code;
joining the other device to the other group if the other device has the invitation code; and
joining the other device to the group if the other device does not have the invitation code.

8. The virtual file sharing method according to claim 6, wherein the other device creates the other group in a cloud server.

9. The virtual file sharing method according to claim 8, further comprising:
transmitting another file information corresponding to another file to the cloud server by the other device;
adding the other file information to the other virtual sharing pool by the cloud server, such that devices of the other group can share the other file stored in the other device.

10. The virtual file sharing method according to claim 9, wherein the other group further comprises another device, and the virtual file sharing method further comprises:
transmitting a request for accessing the other file to the cloud server by the other device;
creating a connection with the other device by the cloud server in response to the access request;
sharing the other file via the cloud server by the other device; and
receiving the other file via the cloud server by the other device.
